(19) United States
(12) Patent Application Publication
(10) Pub. No.: US 2013/0048758 A1
(43) Pub. Date: Feb. 28, 2013

(54) FUEL INJECTION VALVE

(71) Applicant: Kazuhiro Omae, Atsugi-shi (JP)

(72) Inventor: Kazuhiro Omae, Atsugi-shi (JP)

(73) Assignee: TOYOTA JIDOSHA KABUSHIKI KAISHA, Toyota-shi, Aichi-ken (JP)

(21) Appl. No.: 13/695,986

(22) PCT Filed: May 12, 2010
(86) PCT No.: PCT/JP2010/058035

§ 371 Date: Nov. 2, 2012

(51) Int. Cl. F02M 61/18

(52) U.S. Cl. 239/533.12

(57) ABSTRACT

A fuel injection valve includes a nozzle body that includes a suction chamber in its tip portion and an injection aperture opening into the suction chamber; a needle that is slidably located in the nozzle body, and forms a fuel introduction path to the suction chamber between the nozzle body and the needle; and a cylindrically-shaped control member that is positioned by a positioning portion located between an upper edge portion of the suction chamber and the injection aperture in the nozzle body, a position of the upstream edge portion shifting upstream so as to approach the needle when the needle lifts and fuel flows into the suction chamber. As the upstream edge portion approaches the needle, the gap between them remains narrow, and this continually generates cavitation and promotes atomization of the fuel.

### TECHNICAL FIELD

The present invention is related to a fuel injection valve.

### BACKGROUND ART

Atomization of sprayed fuel has been conventionally known to be effective in reducing particulates, which are particulate matters including black exhausts, carbons, and hydrocarbons, emitted from an internal-combustion engine. For example, Patent Document 1 aims to develop the atomization of the sprayed fuel. An injection aperture provided to a fuel injection nozzle disclosed in Patent Document 1 includes a first injection aperture portion at its upstream side and a second injection aperture portion at its downstream side. The second injection aperture portion includes a container portion, which contains a part of a jet outflowing from the first injection aperture portion as a fuel block, between an inner wall of the second injection aperture portion and the jet. That is to say, the fuel injection nozzle disclosed in Patent Document 1 produces cavitation effectively to atomize the fuel by increasing a cross-sectional area of the injection aperture at the downstream side inside the injection aperture.

### PRIOR ART DOCUMENT

### Patent Document

[Patent Document 1] Japanese Patent Application Publication No. 2004-19481

### SUMMARY OF THE INVENTION

### Problems to be Solved by the Invention

However, the amount and flow rate of the fuel flowing into the injection aperture change with a lift amount of a needle in the approach of Patent Document 1. Thus, it is difficult to produce optimum cavitation both when the needle is in a low-lift state and when the needle is in a high-lift state. That is to say, when the cross-sectional area of the injection aperture increases rapidly to produce the cavitation in the fuel, the cavitation hardly occurs because of an insufficient negative pressure due to the increase in a flow passage area of the fuel when the lift amount of the needle increases. On the other hand, when the flow passage area and a shape of the injection aperture are determined so that proper cavitation occurs when the lift amount is increased, excessive cavitation may occur when the needle is in the low-lift state.

The present invention addresses a problem of promoting fuel atomization by producing proper cavitation regardless of the lift amount of the needle.

### Means for Solving the Problems

To solve the above problem, a fuel injection valve disclosed in the present description is characterized by comprising: a nozzle body that includes a suction chamber in a tip portion thereof and an injection aperture opening into the suction chamber; a needle that is slidably located in the nozzle body and forms a fuel introduction path to the suction chamber between the nozzle body and the needle; and a cylindrically-shaped control member that is positioned by a positioning portion located between an upper edge portion of the suction chamber and the injection aperture in the nozzle body, and a position of the upstream edge portion of which shifts upstream so as to approach the needle when the needle lifts and fuel flows into the suction chamber.

The fuel flowing from the fuel introduction path into the suction chamber can produce cavitation at a point where an area of a flow passage increases rapidly or the flow passage curves sharply. As the position of the upstream edge portion of the control member shifts upstream so as to approach the needle with the lift of the needle, a gap between the upstream edge portion of the control member and the needle can remain narrow. The cavitation can be produced by the inflow of the fuel, which has passed between the upstream edge portion of the control member and the needle that remain the narrow gap therebetween, into a region in which a flow passage area is expanded. As described above, even when the lift amount of the needle is changed, the cavitation can be produced efficiently and properly by shifting the position of the upstream edge portion of the control member with the lift of the needle.

The control member may have a first inclined surface, which inclines so as to become closer to a central portion of the nozzle body toward a downstream side, in an upstream portion of an inner peripheral side thereof, and the needle may have a first opposed surface that is increasingly distanced from the first inclined surface toward the downstream side.

The first inclined surface and the first opposed surface, which are distanced from each other, enables to create the region in which the flow passage area is expanded. The cavitation occurs when the fuel, which has passed between the upstream edge portion of the control member and the needle that remain the narrow gap therebetween, flows into a region surrounded by the first inclined surface and the first opposed surface.

The control member may have a second inclined surface, which inclines so as to become closer to an inner wall of the nozzle body toward the downstream side, in a downstream portion of the inner peripheral side. The second inclined surface enables the control member to be lifted by the fuel flowing along the second inclined surface. The upstream edge portion of the control member shifts upstream as the control member lifts.

When the control member includes the second inclined surface as described above, the needle may include a protruding portion that protrudes toward the second inclined surface. The protruding portion narrows the flow passage area between the needle and the second inclined surface, and this enhances the force that is exerted by the fuel passing this region and lifts the control member, and promotes the lift of the control member.

The control member may include a cutout portion, which is located so as to correspond to a position of the injection aperture included in the nozzle body, in a lower end portion thereof. The fuel passes the cutout portion, and then flows into the injection aperture. At this time, the fuel passing the cutout portion can lift the control member. The above described cutout portion may include a pressure receiving surface that inclines from an inner periphery side to an outer periphery side of the control member, and an opening area of an outer peripheral surface of the control member may be smaller than an opening area of an inner peripheral surface of the control member. This allows the control member to be lifted as the fuel passing the cutout portion hits the pressure receiving surface.

The cutout portion may close at least a part of the injection aperture when the control member is positioned in the positioning portion. The state where the control member is positioned is a low-lift state. When the cutout portion closes the part of the injection aperture, the fuel flows into the injection aperture from a biased direction. This makes the fuel flowing into the injection aperture become swirl flow in the injection aperture. In addition, the fuel passing the cutout portion and then flowing into the injection aperture can produce the cavitation. This achieves atomization and lower penetration of the fuel.

The control member may include an elastic member, which is compressed when the needle abuts on the upstream edge portion, between the upstream edge portion and the positioning portion. When released from a compressed state caused by the needle as the needle lifts, the elastic member returns to its original shape by its elasticity. This allows the position of the upstream edge portion of the control member to shift upstream so as to approach the needle. This enables the gap between the upstream edge portion of the control member and the needle to remain narrow. The cavitation occurs by the inflow of the fuel, which has passed between the upstream edge portion of the control member and the needle that remain the narrow gap therebetween, into the region in which the flow passage area is expanded. As described above, the cavitation can be produced efficiently by shifting the upstream edge portion of the control member with the lift of the needle even when the lift amount of the needle changes. The elastic member is re-compressed when the flow rate of the fuel increases and the pressure, which the control member receives from the fuel, increases, and the upstream edge portion shifts downstream. This widen the gap between the upstream edge portion and the needle, and suppresses the cavitation occurrence at the point.

Another fuel injection valve disclosed in the present description is characterized by comprising: a nozzle body that includes a suction chamber in a tip portion thereof and an injection aperture opening into the suction chamber; a needle that is slidably located in the nozzle body, and forms a fuel introduction path to the suction chamber between the nozzle body and the needle; a cylindrically-shaped control member that is positioned by a positioning portion located in the nozzle body, includes a cutout portion, which is located to correspond to a position of the injection aperture included in the nozzle body, in a lower end portion of the control member, and shifts upstream when the needle lifts and fuel flows into the suction chamber. The fuel passes the cutout portion, and then flows into the injection aperture. At this time, the fuel passing the cutout portion can lift the control member. The above described cutout portion may include a pressure receiving surface that inclines from an inner periphery side to an outer periphery side of the control member, and an opening area of an outer peripheral surface of the control member may be smaller than an opening area of an inner peripheral surface of the control member. This allows the control member to be lifted as the fuel passing the cutout portion hits the pressure receiving surface.

The cutout portion may close at least a part of the injection aperture when the control member is positioned in the positioning portion. The state where the control member is positioned is the low-lift state. When the cutout portion closes the part of the injection aperture, the fuel flows into the injection aperture from the biased direction. This makes the fuel flowing into the injection aperture become swirl flow in the injection aperture. The fuel passing the cutout portion and flowing into the injection aperture can produce the cavitation. This achieves the atomization and lower penetration of the fuel.

### Effects of the Invention

The fuel injection valves disclosed in the present description can produce cavitation properly and promote fuel atomization regardless of a lift amount of a needle.

### BRIEF DESCRIPTION OF THE DRAWINGS

FIG. 1 is a schematic view illustrating a tip portion of a fuel injection valve of a first embodiment in an exploded manner;

FIG. 2A is an explanatory diagram illustrating the fuel injection valve in a closed state in the first embodiment, and FIG. 2B is an explanatory diagram illustrating the fuel injection valve in a state where a needle lifts and a control member lifts in the first embodiment;

FIG. 3 is a schematic view illustrating a tip portion of a fuel injection valve of a second embodiment in an exploded manner;

FIG. 4A is an explanatory diagram illustrating the fuel injection valve in the closed state in the second embodiment, FIG. 4B is an explanatory diagram illustrating the fuel injection valve in a low-lift state in the second embodiment, and FIG. 4C is an explanatory diagram illustrating the fuel injection valve in a high-lift state in the second embodiment;

FIG. 5 is a schematic view illustrating a tip portion of a fuel injection valve of a third embodiment in an exploded manner;

FIG. 6A is an explanatory diagram illustrating the fuel injection valve in the closed state in the third embodiment, FIG. 6B is an explanatory diagram illustrating the fuel injection valve in a low flow-rate state in the third embodiment, and FIG. 6C is an explanatory diagram illustrating the fuel injection valve in a high flow-rate state in the third embodiment;

FIG. 7 is a schematic view illustrating a tip portion of a fuel injection valve of a fourth embodiment in an exploded manner;

FIG. 8A-1 is an explanatory diagram illustrating the fuel injection valve in the low-lift state in the fourth embodiment, FIG. 8A-2 is an explanatory diagram illustrating a positional relationship between a cutout portion and an injection aperture in the state illustrated in FIG. 8A-1, FIG. 8B-1 is an explanatory diagram illustrating the fuel injection valve in a middle-lift state in the fourth embodiment, FIG. 8B-2 is an explanatory diagram illustrating the positional relationship between the cutout portion and the injection aperture in the state illustrated in FIG. 8B-1, FIG. 8C-1 is an explanatory diagram illustrating the fuel injection valve in the high-lift state in the fourth embodiment, and FIG. 8C-2 is an explanatory diagram illustrating the positional relationship between the cutout portion and the injection aperture in the state illustrated in FIG. 8C-1; and

FIG. 9A-1 is an explanatory diagram illustrating a fuel injection valve in the low-lift state in a fifth embodiment, FIG. 9A-2 is an explanatory diagram illustrating a positional relationship between a cutout portion and an injection aperture in the state illustrated in FIG. 9A-1, FIG. 9B-1 is an explanatory diagram illustrating the fuel injection valve in the middle-lift state in the fifth embodiment, FIG. 9B-2 is an explanatory diagram illustrating the positional relationship between the cutout portion and the injection aperture in the state illustrated in FIG. 9B-1, FIG. 9C-1 is an explanatory diagram illustrating the fuel injection valve in the high-lift state in the fifth embodiment, and FIG. 9C-2 is an explanatory diagram illustrating the positional relationship between the cutout portion and the injection aperture in the state illustrated in FIG. 9C-1.

### MODES FOR CARRYING OUT THE INVENTION

Hereinafter, a description will be given of modes for carrying out the present invention with reference to the drawings. It should be noted that a size and ratio of each portion do not correspond to the actual ones in some drawings. Also, a detail illustration is omitted in some drawings.

### First Embodiment

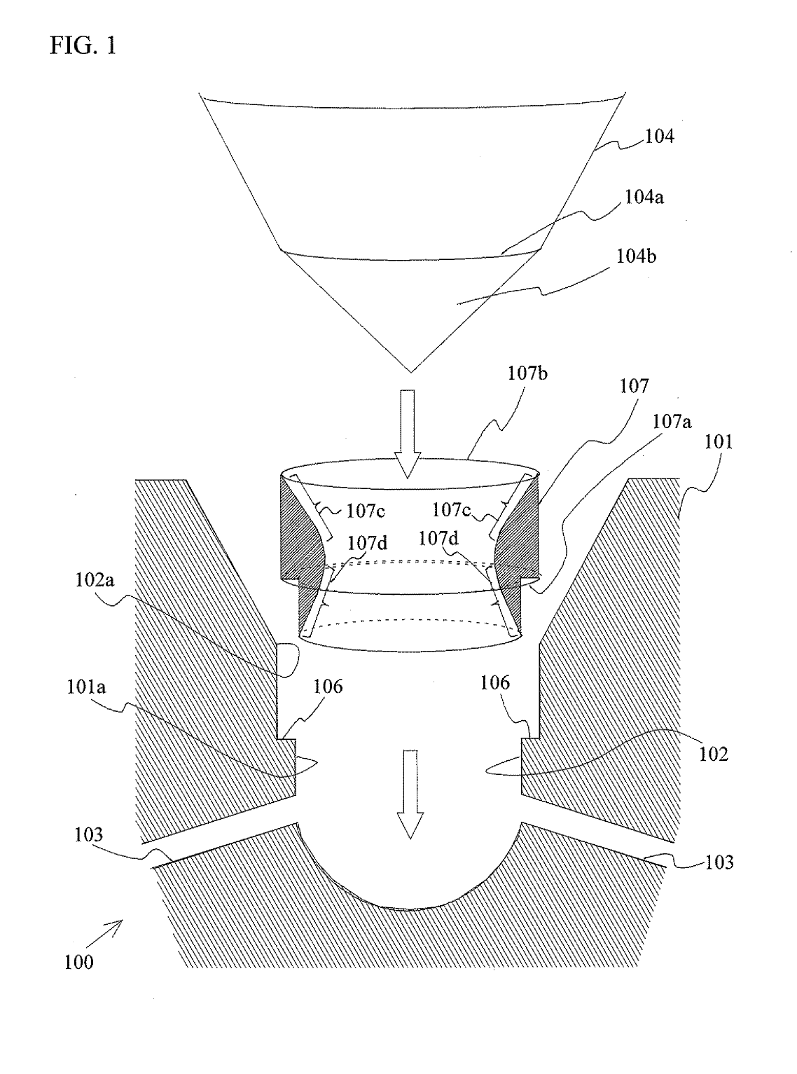

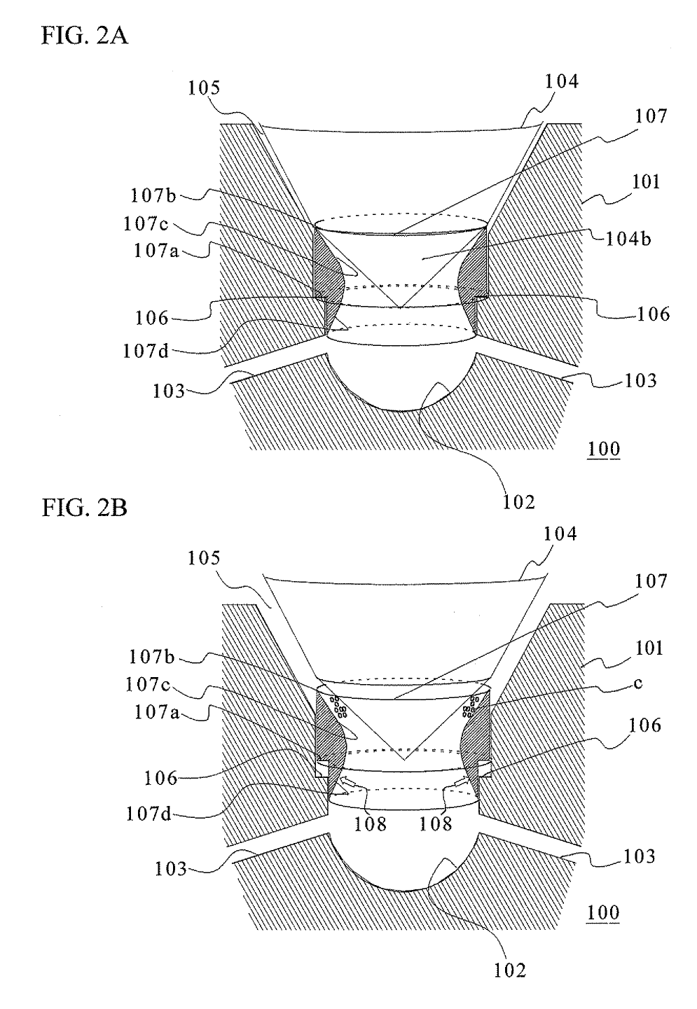

A description will be given of a fuel injection valve 100 in accordance with a first embodiment of the present invention with reference to the drawings. FIG. 1 is a schematic view illustrating a tip portion of the fuel injection valve 100 in an exploded manner. FIG. 2A is an explanatory diagram illustrating the fuel injection valve 100 in a closed state, and FIG. 2B is an explanatory diagram illustrating the fuel injection valve 100 in a state where a needle 104 lifts and a control member 103 lifts.

The fuel injection valve 100 has a nozzle body 101 that includes a suction chamber 102 in its tip portion and injection apertures 103 opening into the suction chamber 102. The four injection apertures 103 are located at regular intervals. The fuel injection valve 100 also includes the needle 104 that is slidably located in the nozzle body 101 and forms a fuel introduction path 105 to the suction chamber 102 between the needle 104 and the nozzle body 101. The needle 104 is driven by a piezoelectric actuator. The nozzle body 101 includes a positioning portion 106 thereinside. The positioning portion 106 is located between an upper edge portion 102a of the suction chamber 102 and the injection aperture 103 in the nozzle body 101, and has a stepped shape as illustrated in the figure.

The fuel injection valve 100 further includes a cylindrically-shaped control member 107. The control member 107 includes a stepped abutment portion 107a, and is positioned when the abutment portion 107a sits on the positioning portion 106. A position of an upstream edge portion 107b of the control member 107 can shift upstream so as to approach the needle 104 when the needle 104 lifts and fuel flows into the suction chamber 102.

The control member 107 has a first inclined surface 107c, which inclines so as to become closer to a central portion of the nozzle body 101 toward a downstream side, in an upstream portion of its inner peripheral side. The control member 107 also has a second inclined surface 107d, which inclines so as to become closer to an inner wall 101a of the nozzle body 101 toward the downstream side, in a downstream portion of its inner peripheral side.

On the other hand, the needle 104 has a first opposed surface 104h, which is increasingly distanced from the first inclined surface 107c toward the downstream side, at a downstream side of a seat portion 104a.

A description will be given of a behavior of the above described fuel injection valve 100 with reference to FIG. 2A and FIG. 2B.

As illustrated in FIG. 2A, when the fuel injection valve 100 is in the closed state, the abutment portion 107a of the control member 107 sits on the stepped positioning portion 106. The seat portion 104a of the needle 104 abutting on the upstream edge portion 107b blocks the fuel flowing from the fuel introduction path 105 into the suction chamber 102.

When the needle 104 starts to lift from the above state, cavitation c occurs between the first inclined surface 107c of the control member 107 and the first opposed surface 104b of the needle 104 as illustrated in FIG. 2B. A gap between the upstream edge portion 107b and the needle 104 is narrow right after the needle 104 starts to lift. Since the first opposed surface 104b is increasingly distanced from the first inclined surface 107c toward the downstream side, and a flow passage area is thus expanded, the cavitation c easily occurs at the above described point.

The fuel that has flowed from the fuel introduction path 105 into the suction chamber 102 flows toward the injection apertures 103. At this time, the fuel flowing along the second inclined surface 107d exerts a force, which is illustrated with an arrow 108 in the figure, on the control member 107. This pushes the control member 107 upstream and lift it. As a result, the position of the upstream edge portion 107b shifts upstream. A shape of the control member 107 itself and surrounding environments of the control member 107 may be other ones as long as a balance of force is ensured to allow the control member 107 to be pushed upstream and lifted.

The upstream shift of the upstream edge portion 107b enables the gap between the upstream edge portion 107b of the control member 107 and needle 104 to remain narrow. The cavitation c can be produced by the inflow of the fuel, which has passed between the upstream edge portion of the control member and the needle that remains the narrow gap therebetween, into a region in which the flow passage area is expanded.

As described above, the fuel injection valve 100 of the first embodiment can produce the cavitation c properly even in a state where the lift amount of the needle 104 is increased.

### Second Embodiment

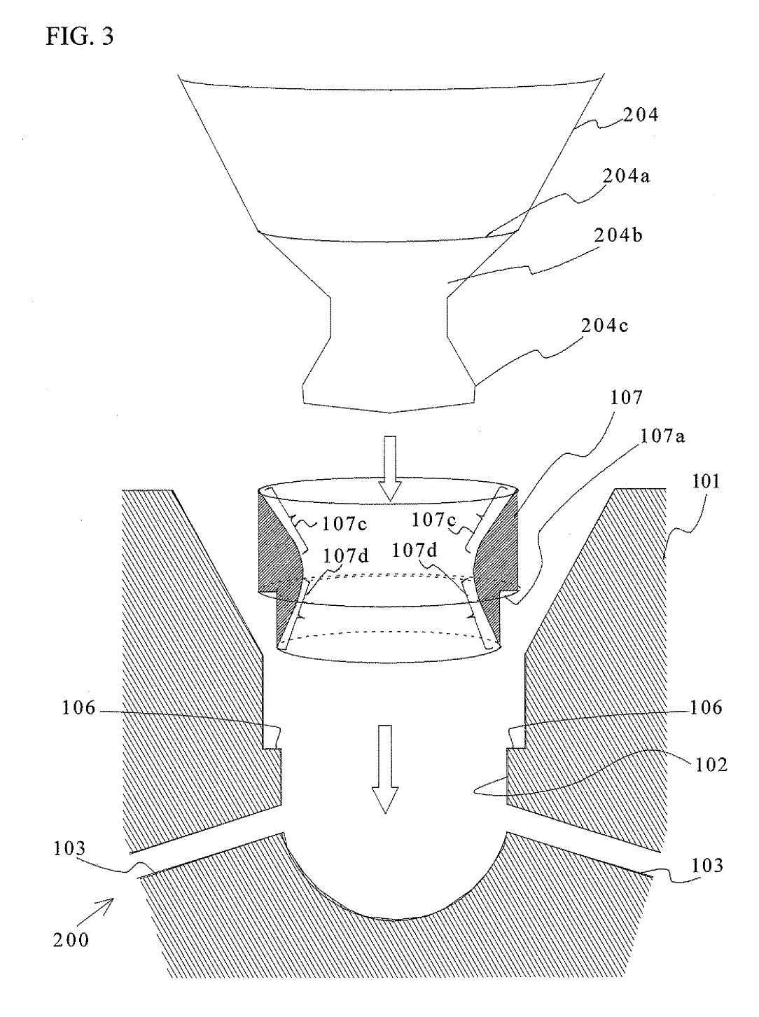

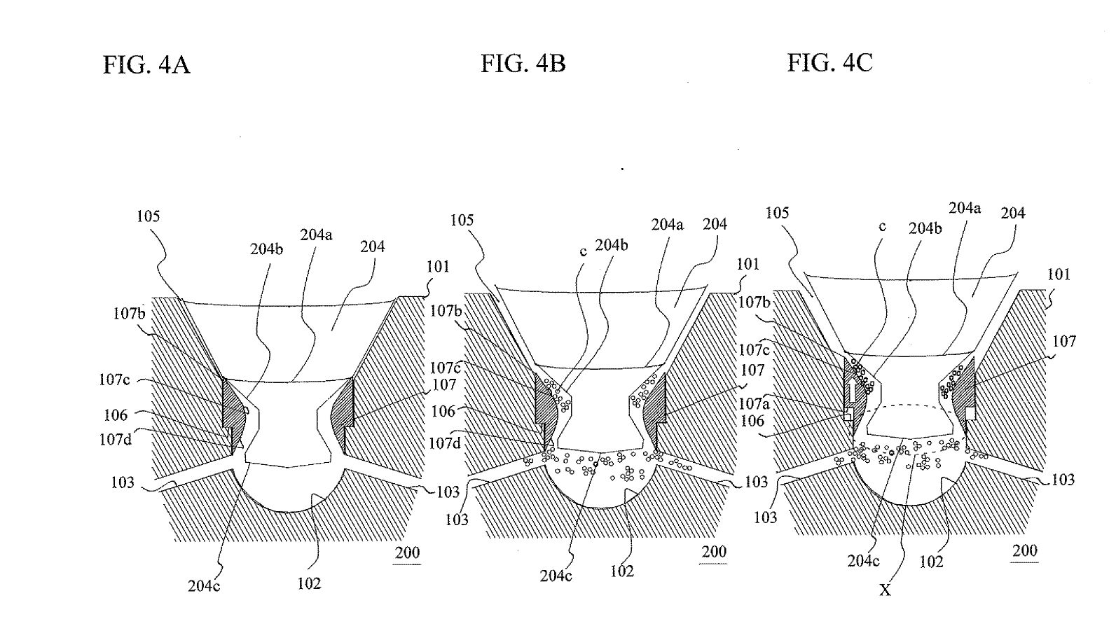

Next, a description will be given of a fuel injection valve 200 of a second embodiment with reference to the drawings. FIG. 3 is a schematic view illustrating a tip portion of the fuel injection valve 200 in an exploded manner. FIG. 4A is an explanatory diagram illustrating the fuel injection valve 200 in the closed state. FIG. 4B is an explanatory diagram illustrating the fuel injection valve 200 in the low-lift state. FIG. 4C is an explanatory diagram illustrating the fuel injection valve 200 in a high-lift state.

The fuel injection valve 200 of the second embodiment differs from the fuel injection valve 100 of the first embodiment in that the fuel injection valve 200 includes a needle 204 instead of the needle 104. The fuel injection valve 200 includes the nozzle body 101 and the control member 107 as well as the fuel injection valve 100. The composition elements common to the fuel injection valve 100 and the fuel injection valve 200 are affixed with the same reference numerals in the drawings, and their detail descriptions are omitted.

The needle 204 includes a first opposed surface 204b at a downstream side of a seat portion 204a as with the needle 104 of the first embodiment. The first opposed surface 204b is a surface opposing to the first inclined surface 107c included in the control member 107. The first opposed surface 204b is increasingly distanced from the first inclined surface 107e toward the downstream side.

The needle 204 further includes a protruding portion 204c that protrudes toward the second inclined surface 107d included in the control member 107. The control member 107 is pushed upstream by a balance between pressures of the fuel acting on it from the upstream and downstream sides.

The protruding portion 204c makes a distance from the second inclined surface 107d narrow. This strengthen a force, which lifts the control member 107, of the fuel flowing between the protruding portion 204c and the second inclined surface 107d. This enables to easily maintain the balance of the force pushing the control member 107 upstream.

The shape of the control member 107 itself and surrounding environments of the control member 107 may be other ones as long as the balance of the force is ensured to allow the control member 107 to be pushed upstream and lifted.

A description will be given of a behavior of the fuel injection valve 200 with reference to FIG. 4A, FIG. 4B, and FIG. 4C.

As illustrated in FIG. 4A, when the fuel injection valve 100 is in the closed state, the abutment portion 107a of the control member 107 sits on the stepped positioning portion 106. The seat portion 204a of the needle 204 abutting on the upstream edge portion 107b blocks the fuel flowing from the fuel introduction path 105 into the suction chamber 102.

When the needle 204 starts to lift and is then in the low-lift state as illustrated in FIG. 4B, the cavitation c occurs between the first inclined surface 107c of the control member 107 and the first opposed surface 204b of the needle 204. The gap between the upstream edge portion 107b of the control member 107 and the needle 204 is narrow right after the needle 104 starts to lift. Since the first opposed surface 204b is increasingly distanced from the first inclined surface 107c toward the downstream side, and the flow passage area is expanded, the cavitation c easily occurs at the above described point.

As illustrated in FIG. 4C, when the needle 204 becomes in the high-lift state, a large amount of the fuel, which has flowed from the fuel introduction path 105 into the suction chamber 102, pushes the control member 107 upstream when passing a region indicated with a reference symbol X in the figure. That is to say, the needle 204 becomes in the high-lift state, and the amount of the fuel flowing into the suction chamber 102 increases. When the large amount of the fuel passes the narrowed region, the control member 107 is pushed upstream to ensure a flow volume.

When the control member 107 is pushed upstream, the position of the upstream edge portion 107b shifts upstream. The upstream shift of the upstream edge portion 107b enables the gap between the upstream edge portion 107b of the control member 107 and the needle 204 to remain narrow. The cavitation c can be produced by the inflow of the fuel, which has passed between the upstream edge portion 107b of the control member 107 and the needle 204 that remain the narrow gap therebetween, into the region in which the flow passage area is expanded.

As described above, the fuel injection valve 200 of the second embodiment can produce the cavitation c properly even in a state where the lift amount of the needle 204 is increased.

### Third Embodiment

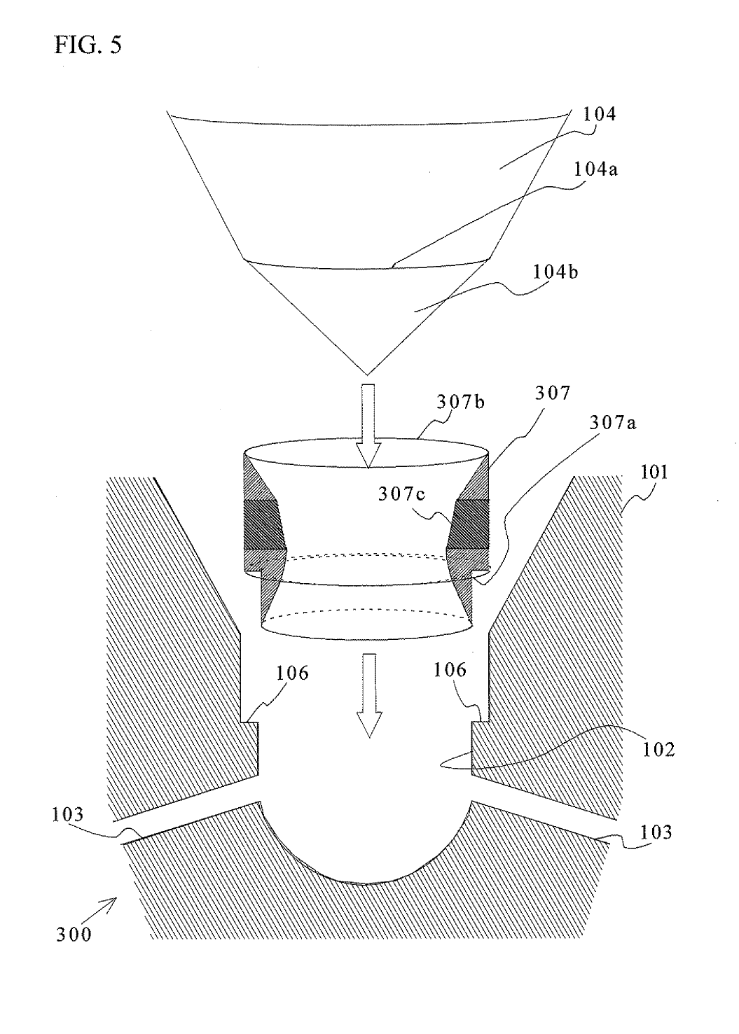

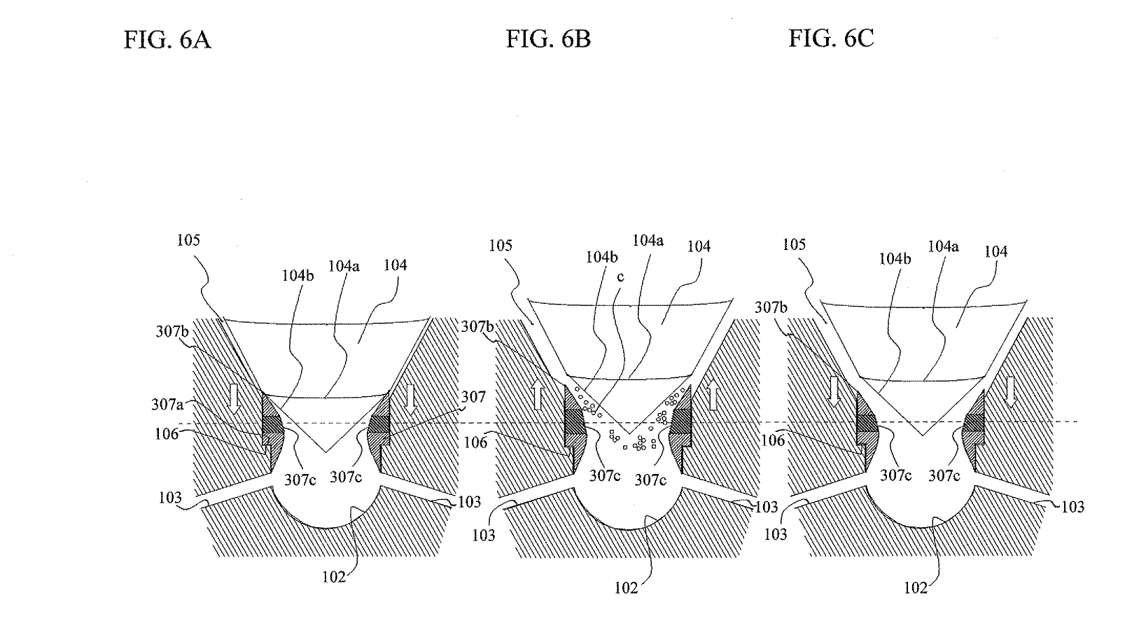

Next, a description will be given of a fuel injection valve 300 of a third embodiment with reference to the drawings. FIG. 5 is a schematic view illustrating a tip portion of the fuel injection valve 300 in an exploded manner. FIG. 6A is an explanatory diagram illustrating the fuel injection valve 300 in the closed state. FIG. 6B is an explanatory diagram illustrating the fuel injection valve in a low flow-rate state. FIG. 6C is an explanatory diagram illustrating the fuel injection valve 300 in a high flow-rate state.

The fuel injection valve 300 of the third embodiment differs from the fuel injection valve 100 of the first embodiment in that the fuel injection valve 300 includes a control member 307 instead of the control member 107. The fuel injection valve 300 includes the nozzle body 101 and the needle 104 as well as the fuel injection valve 100. The composition elements common to the fuel injection valve 100 and the fuel injection valve 300 are affixed with the same reference numerals, and their detail descriptions are omitted.

The control member 307 includes an elastic member 307c between an upstream edge portion 307b and an abutment portion 307a that abuts on the positioning portion 106. The elastic member 307c is compressed when the needle 104 abuts on the upstream edge portion 307b. When the elastic member 307c becomes in a compressed state, a position of the upstream edge portion 307b shifts downstream, and when released from the compressed state, the elastic member 307c returns to its original shape by its elasticity. This allows the position of the upstream edge portion 307b of the control member 307 to shift upstream so as to approach the needle 104. The control member 307 is not bonded to the positioning portion 106, but the abutment portion 307a is usually seated on the positioning portion 106 because of a balance of fuel pressure or the like.

A description will be given of a behavior of the above described fuel injection valve 300 with reference to FIG. 6A, FIG. 6B, and FIG. 6C.

As illustrated in FIG. 6A, when the fuel injection valve 300 is in the closed state, the abutment portion 307a of the control member 307 sits on the stepped positioning portion 106. The seat portion 104a of the needle 104 abutting on the upstream edge portion 307b blocks the fuel flowing from the fuel introduction path 105 into the suction chamber 102. At this point, the needle 104 depresses the control member 307, and the elastic member 307c becomes in the compressed state.

When the needle 104 starts to lift from the above state, and separates from the upstream edge portion 307b as illustrated in FIG. 6B, the elastic member 307c is released from the compressed state caused by the pressure from the needle 104. The state illustrated in FIG. 6B is a low flow-rate state, and the pressure of the fuel around the control member 307 becomes low in this state. Therefore, the elastic member 307c returns to its original shape, and the position of the upstream edge portion 307b shifts upstream.

When the upstream edge portion 307b shifts upstream, the distance from the needle 104 is maintained narrow. The cavitation c can be produced by the inflow of the fuel, which has passed between the upstream edge portion 307b of the control member 307 and the needle 104 that remains the narrow gap therebetween, into the region in which the flow passage area is expanded.

As illustrated in FIG. 6C, when the fuel becomes in the high flow-rate state, the atomization of the fuel due to the flow rate of ejected fuel is expected, and the atomization of the spray by producing the cavitation c is not highly required. As described, when the fuel becomes in the high flow-rate state, the pressure of the fuel around the control member 307 becomes high. Thus, the elastic member 307c becomes in the compressed state, and the position of the upstream edge portion 307b shifts downstream. This widens the gap between the upstream edge portion 307b and the needle 104, and suppresses the occurrence of the cavitation c in the fuel that has passed between the upstream edge portion 307b of the control member 307 and the needle 104.

As described above, the fuel injection valve 300 of the third embodiment can produce the cavitation c properly even in a state where the lift amount of the needle 104 is increased.

### Fourth Embodiment

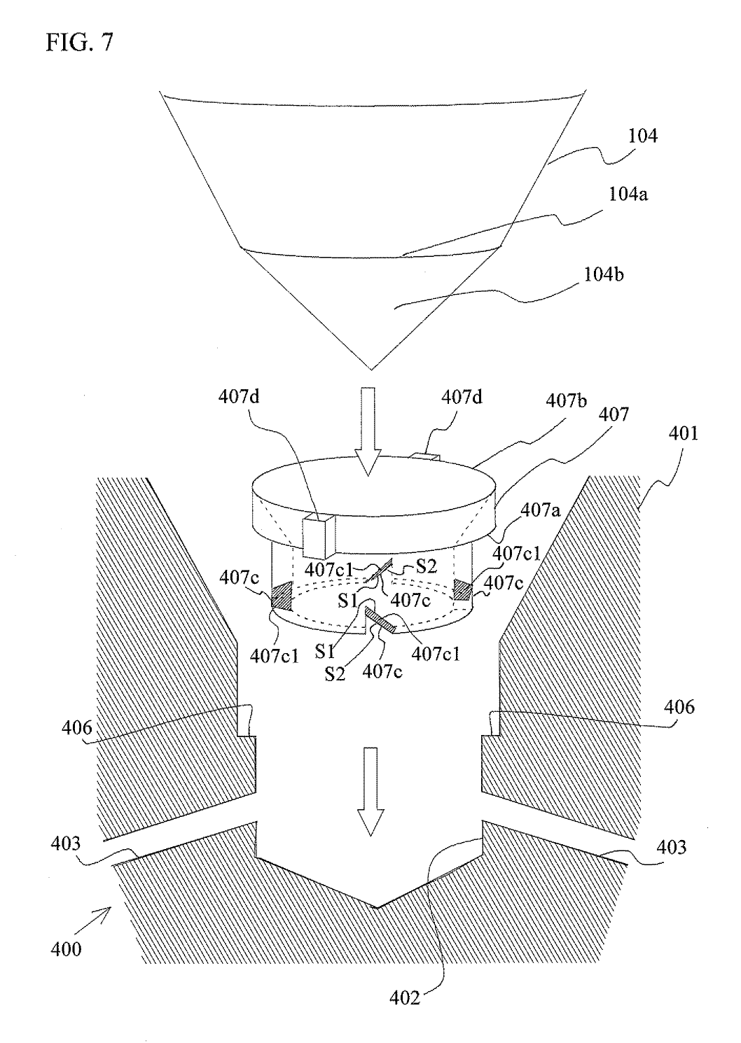

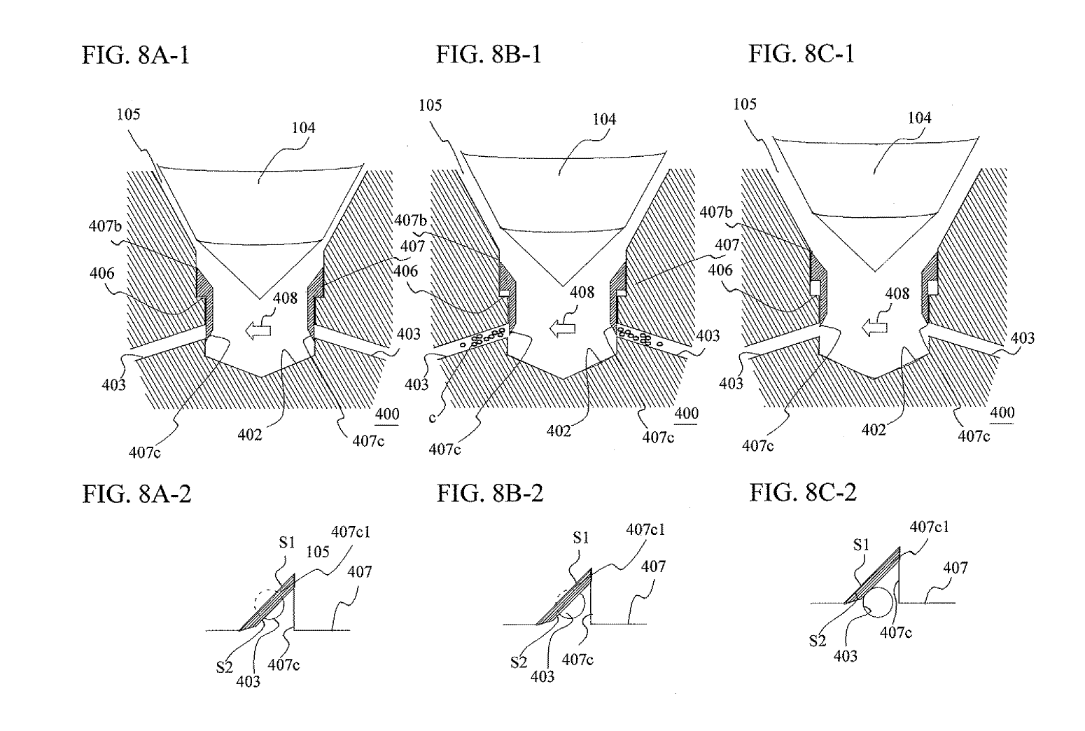

A description will now be given of a fuel injection valve 400 of a fourth embodiment. FIG. 7 is a schematic view illustrating a tip portion of the fuel injection valve 400 in an exploded manner. FIG. 8A-1 is an explanatory diagram illustrating the fuel injection valve 400 in the low-lift state, and FIG. 8A-2 is an explanatory diagram illustrating a positional relationship between a cutout portion 407c and an injection aperture 403 in the state illustrated in FIG. 8A-1. FIG. 8B-1 is an explanatory diagram illustrating the fuel injection valve 400 in a middle-lift state, and FIG. 8B-2 is an explanatory diagram illustrating the positional relationship between the cutout portion 407c and the injection aperture 403 in the state illustrated in FIG. 8B-1. FIG. 8C-1 is an explanatory diagram illustrating the fuel injection valve 400 in the high-lift state, and FIG. 8C-2 is an explanatory diagram illustrating the positional relationship between the cutout portion 407c and the injection aperture 403 in the state illustrated in FIG. 8C-1.

The fuel injection valve 400 of the fourth embodiment differs from the fuel injection valve 100 of the first embodiment in that the fuel injection valve 400 includes a cylindrically-shaped control member 407 instead of the control member 107. The fuel injection valve 400 includes the needle 104 as well as the fuel injection valve 100. In addition, a nozzle body 401 is used instead of the nozzle body 101 as the control member 407 is used. The nozzle body 401 is similar to the nozzle body 101 of the first embodiment in that it includes a suction chamber 402, the injection aperture 403, and a positioning portion 406. Four injection apertures 403 are located at equal interval in the same manner as those in the nozzle body 101 of the first embodiment. The composition elements common to the fuel injection valve 100 and the fuel injection valve 400 are affixed with the same reference numerals in the drawings, and their detail descriptions are omitted.

The control member 407 shifts upstream when the needle 104 lifts and the fuel flows into the suction chamber 402. The control member 407 includes a stepped abutment portion 407a, and is positioned when the abutment portion 407a is seated on the positioning portion 406. The control member 407 includes four cutout portions 407c, which are located to correspond to positions of four injection aperture 403, in its lower end portion.

The cutout portion 407c includes a pressure receiving surface 407c1 that inclines from an inner periphery side to an outer periphery side of the control member 407. In addition, the control member 407 has a shape in which an opening area S2 of an outer peripheral surface is smaller than an opening area S1 of an inner peripheral surface of the control member 407. Openings of inner and outer peripheral surfaces of the cutout portion 407c have a triangular shape.

The control member 407 includes a rotation stopper 407d. The rotation stopper 407d prevents a rotation against the nozzle body 401. This maintains the positional relationship between the injection aperture 403 and the cutout portion 407c.

A description will be given of a behavior of the above described fuel injection valve 400 with reference to FIG. 8A-1 through FIG. 8C-2.

The fuel injection valve 400 illustrated in FIG. 8A-1 is in the low-lift state. At this point, the control member 407 is positioned in the positioning portion 406. FIG. 8A-2 illustrates the cutout portion 407c observed from a direction indicated with an arrow 408 in FIG. 8 A-1, i.e. from an inside of the control member 407. The cutout portion 407c interferes with the injection aperture 403 and closes a part of the injection aperture 403 while the control member 407 is positioned in the positioning portion 406. As the cutout portion 407c closes the part of the injection aperture 403, the fuel flows into the injection aperture 403 from a biased direction. This makes the fuel flowing into the injection aperture 403 become swirl flow in the injection aperture 403. The fuel passing the cutout portion 407c and then flowing into the injection aperture produces the cavitation c. This achieves the atomization and lower penetration of the fuel.

The fuel injection valve 400 illustrated in FIG. 8B-1 is in the middle-lift state. At this time, the control member 407 floats above the positioning portion 406. The reason why the control member 407 floats as illustrated is because the control member 407 is lifted by the fuel passing the cutout portion 407c and then flowing into the injection aperture 403. The impingement of the fuel against the pressure receiving surface 407e1 included in the control member 407 enhances the force lifting the control member 407. FIG. 8B-2 illustrates the cutout portion 407c observed from a direction indicated with the arrow 408 in FIG. 8B-1, i.e. from the inside of the control member 407. When the control member 407 is lifted, a communication area between the cutout portion 407c and the injection aperture 403 increases. This ensures a desired injection amount. In addition, as a boundary between the lower end portion of the cutout portion 407c and the injection aperture 403 produces the cavitation c, a state where the atomization of the spray is promoted is maintained.

The fuel injection valve 400 illustrated in FIG. 8C-1 is in the high-lift state. The control member 407 in this state lifts higher than that in the middle-lift state. The reason why the control member 407 lifts as described above is because the control member 407 is lifted by the fuel passing the cutout portion 407c and then flowing into the injection aperture 403. FIG. 8C-2 illustrates the cutout portion 407c observed from the direction indicated with the arrow 408 in FIG. 8C-1, i.e. from the inside of the control member 407. When the control member 407 is lifted, the cutout portion 407c does not interfere with the injection aperture 403, and the opening portion of the injection aperture 403 is fully opened. This ensures the amount of the fuel flowing into the injection aperture 403. As described above, when the cutout portion 407c does not interfere with the injection aperture 403, the occurrence of the cavitation c almost stops at the entrance of the injection aperture 403.

As described above, the fuel injection valve 400 of the fourth embodiment can produce the cavitation c in the low-lift state and the middle-lift state, and ensure the flow volume of the fuel in the high-lift state. An upstream edge portion 407b of the control member 407 does not contribute to the occurrence of the cavitation c in the fourth embodiment.

### Fifth Embodiment

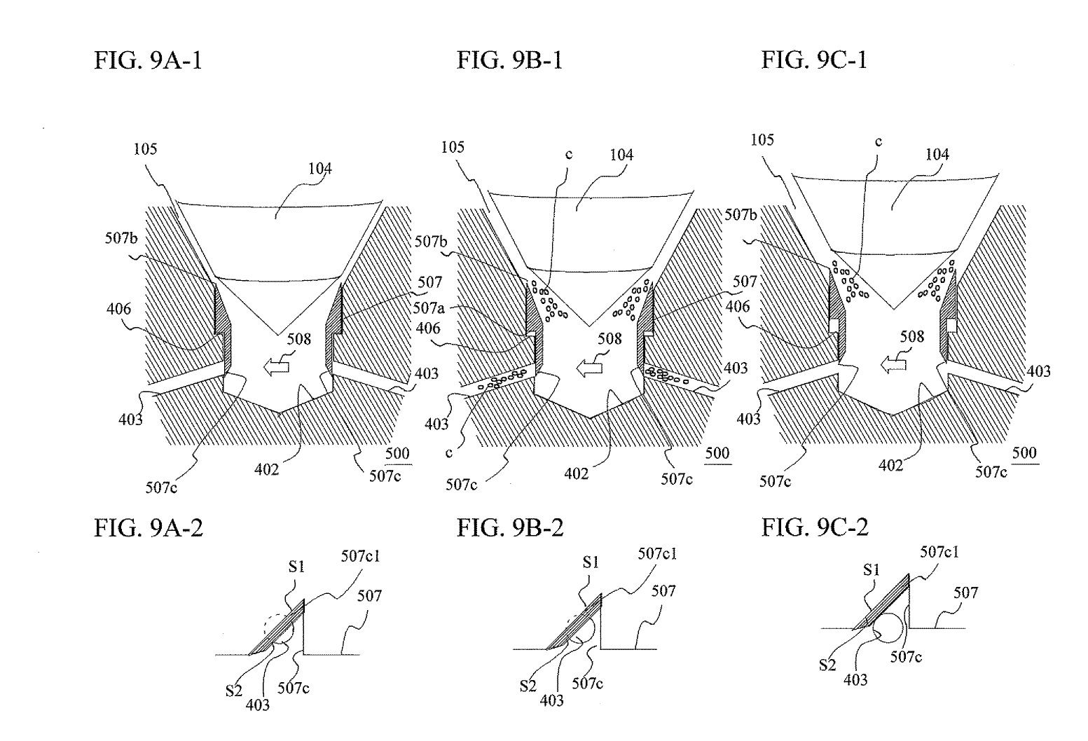

A description will now be given of a fuel injection valve 400 of a fifth embodiment. FIG. 9A-1 is an explanatory diagram of the fuel injection valve 500 in the low-lift state, and FIG. 9A-2 is an explanatory diagram illustrating a positional relationship between a cutout portion 507c and the injection aperture 403 in the state illustrated in FIG. 9A-1. FIG. 9B-1 is an explanatory diagram illustrating the fuel injection valve 500 in the middle-lift state, and FIG. 9B-2 is an explanatory diagram illustrating the positional relationship between the cutout portion 507c and the injection aperture 403 in the state illustrated in FIG. 9B-1. FIG. 9C-1 is an explanatory diagram illustrating the fuel injection valve 500 in the high-lift state, and FIG. 8C-2 is an explanatory diagram illustrating the positional relationship between the cutout portion 507c and an injection aperture 503 in the state illustrated in FIG. 8C-1.

The fuel injection valve 500 of the fifth embodiment differs from the fuel injection valve 400 of the fourth embodiment in that the fuel injection valve 500 includes a control member 507 instead of the control member 407. As the fuel injection valve 500 does not practically differ from the fuel injection valve 400 of the fourth embodiment in other points, common composition elements are affixed with the same reference numerals, and their detail descriptions are omitted.

The control member 507 includes an abutment portion 507a, an upstream edge portion 507b, and the cutout portion 507c as well as the control member 407 of the fourth embodiment. However, the upstream edge portion 507b is located more upstream than the upstream edge portion 407b of the control member 407. That is to say, the control member 507 includes the upstream edge portion 507b made by extending the upstream edge portion 407b of the control member 407 to the upstream side.

The fifth embodiment makes the control member 507 have the above described shape to obtain the effect of the first embodiment and the effect of the fourth embodiment. That is to say, the fifth embodiment can produce the cavitation c between the upstream edge portion 507b of the control member 507 and the needle 104 and in the injection apertures 403.

A description will be given of a behavior of the above described fuel injection valve 500 with reference to FIG. 9A-1 through FIG. 9C-2.

The fuel injection valve 500 illustrated in FIG. 9A-1 is in the low-lift state. At this point, the control member 507 is positioned in the positioning portion 406. FIG. 8A-2 illustrates the cutout portion 507c observed from a direction indicated with an arrow 508 in FIG. 8A-1, i.e. from an inside of the control member 507. The cutout portion 507c interferes with the injection aperture 403 and closes a part of the injection aperture 403 when the control member 507 is positioned in the positioning portion 406. As the cutout portion 407c closes the part of the injection aperture 403, the fuel flows into the injection aperture 403 from the biased direction. This makes the fuel flows into the injection aperture 403 become swirl flow in the injection aperture 403. In addition, the fuel passing the cutout portion 407c and then flowing into the injection aperture produces the cavitation c. Furthermore, the cavitation c occurs between the upstream edge portion 507b and the needle 104. This achieves the atomization and lower penetration of the fuel.

The fuel injection valve 500 illustrated in FIG. 98-1 is in the middle-lift state. At this point, the control member 507 floats above the positioning portion 406. The reason why the control member 507 floats as described above is because the control member 507 is lifted by the fuel passing the cutout portion 507c and then flowing into the injection apertures 403. The force lifting the control member 507 is enhanced by the impingement of the fuel against the pressure receiving surface 407c1 included in the control member 407. FIG. 9B-2 illustrates the cutout portion 507c observed from the direction illustrated with the arrow 508 in FIG. 9B-1, i.e. from the inside of the control member 507. When the control member 507 is lifted, a communication area between the cutout portion 507c and the injection aperture 403 increases. This ensures a desired injection amount. In addition, a boundary between a lower end portion of the cutout portion 507c and the injection aperture 403 produces the cavitation c. Furthermore, as the control member 507 is pushed upstream, the position of the upstream edge portion 507b shifts upstream, and the gap between the upstream edge portion 507b of the control member 507 and the needle 104 can remain narrow. This enables to produce the cavitation c. The above behavior maintains a state where the atomization of the spray is promoted.

The fuel injection valve 500 illustrated in FIG. 9C-1 is in the high-lift state. The control member 507 in this state lifts higher than that in the middle-lift state. The reason why the control member 507 lifts as described above is because the control member 507 is lifted by the fuel passing the cutout portion 507c and then flowing into the injection aperture 403 as described previously. FIG. 9C-2 illustrates the cutout portion 507c observed from the direction indicated with the arrow 508 in FIG. 9C-1, i.e. from the inside of the control member 507. When the control member 507 is lifted, the cutout portion 507c does not interfere with the injection aperture 403, and the opening portion of the injection aperture 403 is fully opened. This ensures the amount of the fuel flowing into the injection apertures 403. As described above, when the cutout portion 507c does not interfere with the injection aperture 403, the occurrence of the cavitation c almost stops at the entrance of the injection aperture 403. However, the upstream edge portion 507b shifts upstream because the control member 507 is pushed further upstream. This allows the gap between the upstream edge portion 507b of the control member 507 and the needle 104 to remain narrow, and enables to keep producing the cavitation.

As described above, the fuel injection valve 500 of the fifth embodiment can produce the cavitation c properly in the low-lift state and the middle-lift state. Furthermore, it can ensure the flow volume and produce the cavitation in the high-lift state.

Above described embodiments are exemplary embodiments carrying out the present invention. Therefore, the present invention is not limited to those, and various modification and change could be made hereto without departing from the spirit and scope of the claimed present invention.

### DESCRIPTION OF LETTERS OR NUMERALS

100, 200, 300, 400, 500 . . . fuel injection valve
101, 401 . . . nozzle body
102, 402 . . . suction chamber
102a . . . upper edge portion of suction chamber
103, 403 . . . injection aperture
104, 204 . . . needle
104a, 204a . . . seat portion
104b, 204b . . . first opposed surface
204c . . . protruding portion
105 . . . fuel introduction path
106 . . . positioning portion
107, 307, 407, 507 . . . control member
107a, 307a, 407a, 507a . . . abutment portion
107b, 307b, 407b, 507b . . . upstream edge portion
307c . . . elastic member
407c . . . cutout portion
407c1 . . . pressure receiving surface
407d . . . rotation stopper

1. A fuel injection valve comprising:
a nozzle body that includes a suction chamber in a tip portion thereof and an injection aperture opening into the suction chamber;
a needle that is slidably located in the nozzle body, and forms a fuel introduction path to the suction chamber between the nozzle body and the needle; and
a cylindrically-shaped control member that is positioned by a positioning portion located between an upper edge portion of the suction chamber and the injection aperture in the nozzle body, and a position of the upstream edge portion of which shifts upstream so as to approach the needle when the needle lifts and fuel flows into the suction chamber, wherein
the control member has a second inclined surface, which inclines so as to become closer to an inner wall of the nozzle body toward a downstream side, in a downstream portion of the inner peripheral side.

2. The fuel injection valve according to claim 1, wherein
the control member has a first inclined surface, which inclines so as to become closer to a central portion of the nozzle body toward the downstream side, in an upstream portion of an inner peripheral side thereof, and
the needle has a first opposed surface that is increasingly distanced from the first inclined surface toward the downstream side.

3. (canceled)

4. The fuel injection valve according to claim 1, wherein
the needle includes a protruding portion that protrudes toward the second inclined surface.

5. The fuel injection valve according to claim 1, wherein
the control member includes a cutout portion, which is located so as to correspond to a position of the injection aperture included in the nozzle body, in a lower end portion thereof.

6. The fuel injection valve according to claim 5, wherein
the cutout portion includes a pressure receiving surface that inclines from an inner periphery side to an outer periphery side of the control member, and
an opening area of an outer peripheral surface of the control member is smaller than an opening area of an inner peripheral surface of the control member.

7. The fuel injection valve according to claim 5, wherein
the cutout portion closes at least a part of the injection aperture when the control member is positioned in the positioning portion.

8. The fuel injection valve according to claim 1, wherein
the control member includes an elastic member, which is compressed when the needle abuts on the upstream edge portion, between the upstream edge portion and the positioning portion.

9. A fuel injection valve comprising:
a nozzle body that includes a suction chamber in a tip portion thereof and an injection aperture opening into the suction chamber;
a needle that is slidably located in the nozzle body, and forms a fuel introduction path to the suction chamber between the nozzle body and the needle;
a cylindrically-shaped control member that is positioned by a positioning portion located in the nozzle body, includes a cutout portion, which is located to correspond to a position of the injection aperture included in the nozzle body, in a lower end portion of the control member, and shifts upstream when the needle lifts and fuel flows into the suction chamber, wherein
the cutout portion includes a pressure receiving surface that inclines from an inner periphery side to an outer periphery side of the control member, and
an opening area of an outer peripheral surface of the control member is smaller than an opening area of an inner peripheral surface of the control member.

10. (canceled)

11. The fuel injection valve according to claim 9, wherein
the cutout portion closes at least a part of the injection aperture when the control member is positioned in the positioning portion.
